(19) United States
(12) Patent Application Publication
(10) Pub. No.: US 2014/0197562 A1
(43) Pub. Date: Jul. 17, 2014

(54) COMPOSITE MATERIAL FOR MAKING ARTICLES OUT OF POLYURETHANE DOPED WITH POLYMERIC GEL AND THE PROCEDURE FOR MAKING IT

(71) Applicant: New Wind S.R.L., Ostuni (IT)

(72) Inventors: Filippo Piccinini, Padova (IT); Nilso Cruccas, Francavilla sul Sinni (IT)

(73) Assignee: New Wind S.R.L., Ostuni (IT)

(21) Appl. No.: 14/119,739

(22) PCT Filed: May 22, 2012
(86) PCT No.: PCT/IB12/52566

§ 371 Date: Nov. 22, 2013

(30) Foreign Application Priority Data
May 23, 2011 (IT) PD2011A000164

(51) Int. Cl. C08L 75/04; C08J 9/00; C08L 9/06

(52) U.S. Cl. CPC C08L 75/04; C08L 9/06; C08J 9/0014
USPC 264/54; 521/131

(57) ABSTRACT

A standard polyurethane doped with a polymeric gel uniformly diffused in the body, where the polyurethane acquires the properties of the gel without any change to its structure in a durable stable manner.

### CROSS-REFERENCE TO RELATED APPLICATIONS

This application claims the benefit of Italian Patent Application PD2011A000164, filed on May 23, 2011, and PCT Application PCT/IB2012/052566, filed on May 22, 2012, both incorporated herein by reference.

### FIELD OF THE INVENTION

The object of the invention is a product composed of a flexible polyurethane foam and a polymeric gel and the relative production process for making it, which is to be used as a padding material, in particular for mattresses, pillows and bedding articles, in footwear, in the car industry, providing the required characteristics in a durable stable manner, with a reliable and inexpensive production process that includes the steps of delivering a polyurethane foam to be expanded on a continuous production conveyor using a foaming head or a mold, where said polyurethane mix has granules of polymeric gel added to it.

### DISCUSSION OF RELATED ART

As is well known, open or closed cell polyurethane foam in the various available densities is used in many fields.

The chemistry of the polyurethane is based on the reaction of isocyanates with molecules containing active hydrogenates. The —NCO groups contained in the isocyanate molecule react quickly, in the presence of suitable catalysts, with hydrogen atoms bound to more electronegative atoms of carbon.

This reaction leads to the formation of the polymeric structure, with the associated production of carbon dioxide when water is present in the reaction.

Normally, for the production of finished polyurethane foam products you can use a mold or else, more frequently, a process for producing continuous blocks that are later cut and shaped. From storage tanks, suitably sized and structured for the raw materials and additives that are used, the chemical components are transported using dosing pumps into a mixing room where the raw materials and the additives are weighed and mixed according to a fixed formula. The isocyanate raw material does not take part in this dosing. The isocyanate and the mix obtained in the mix room are sent by means of dosing pumps to the mixing and supply head. The mixing and supply head is part of a foaming line where, in the case of the production of continuous blocks, a conveyor of polyurethane foam is produced, with a prearranged height and cut to the desired length for the production of long blocks of polyurethane. The blocks of polyurethane obtained in this manner are stored in tiers where they mature. In the case of mold production, the production line is composed of a series of molds having the shape of the product you want to make, the production sequence is the same, and you put a set amount of product in the mold using the mixing head, the mold is closed, and the polymerization reaction takes place inside and then later the piece is taken out and put in tiers for maturation.

The introduction into the production process of additive substances with special mechanical or physical properties is extremely critical. The formulation of the polyurethane, in fact, requires a skilful balance in order to provide a foam product with regular and homogeneous characteristics, and to therefore provide an industrially acceptable product with the desired characteristics. If additives are used these could cause unwanted reactions between the main additive and the raw materials used in the process for producing flexible polyurethane foams, thereby causing instability in the system and a loss of the characteristics of the additive.

The addition of acrylonitrile butadiene styrene, with characteristics that leave a lot to be desired, to the polyurethane mix in the process of forming is well known.

Indeed, the performances of the polyurethane do not change, except for the mass, in an insignificant manner, while high concentrations lead to a decline of the product over the long term.

In fact the increase in rigidity with the addition of styrene acrylonitrile and butadiene loads to obtain polyurethane that is a little more rigid, and in any event to improve the physical characteristics of the product, does not achieve the desired effect in appreciable percentage.

Also the addition of calcium carbonate and the like does not obtain any other effect.

On the market there are particular polyoils already doped with acrylonitrile butadiene styrene (normally called SAN), however they do not achieve a significant increase in the characteristics compared to the polyurethane doped afterwards.

In particular, none of the current polyurethanes doped afterwards, or the SAN variety, offer a high viscoelasticity compared to standard polyurethanes, and in particular they have a modest energy absorption coefficient value.

In order to get around the above-mentioned drawbacks there was also an attempt in the past to combine the polyurethane gel, both before and during the polymerization phase, to one of the ingredients, with poor results because the gel does not disperse in the mass of the polyurethane.

Other tests were carried out combining a polyurethane gel after a first and partial polymerization; however the surface accumulation led to the inevitable detachment in the long term because the substances had no affinity to one another.

In the broad diversity of products obtainable, it is well known that the use of additives should take place in the form of powder in order to allow for foaming.

All attempts up until now to insert additives in the posterior phase to the foaming have proven to be limited only to the surface layer.

Moreover, in the eventuality that these additives have no chemical affinity with the chemical structure of the polyurethane, like for example a polymeric gel, the surface diffusion creates an upper layer of film that is only partially integrated into the substrate.

This layer of film has shown to be unstably joined to the body of the substrate of the polyurethane, and over time this union breaks down with the separation of the entire upper part of the additive, either in the form of a film or in the form of small surface elements.

This drawback, especially regarding the reliability of the cohesion, has led to experiments with other additives, to be added in the form of powder, which have some affinity with the polyurethane.

It is well known that the polymeric gel, in order to be able to provide a feeling of freshness, has to find itself united in discrete elements sufficiently large and substantial to be able to absorb, at least in the initial phase, the heat of the person resting on top of it.

We have seen, however, that these discrete elements deposited afterwards to the foaming are settled only on the surface and cannot get inside the structure, and over time they break off.

Finally, the production procedure for combining said polymeric gel to one of the polyurethane components, the polyoil, or to the mixt of polyoil and isocyanate, has serious drawbacks if carried out near the foaming.

Indeed, the gel element does not sufficiently stick to the structure of the polyurethane, with the result that the polymeric gel on the surface separates over time following rubbing and wear.

### SUMMARY OF THE INVENTION

In this situation the main objective of this invention is to make available a composite material for making polyurethane items doped with polymeric gel that has better mechanical and physical properties than the doped polyurethane available on the market.

In particular, the objective of this invention is to make available a composite material for making items out of polyurethane doped with polymeric gel that has improved viscoelastic properties, with a lowering of the glass transition point with respect to the doped polyurethane available on the market.

A further objective of this invention is make a polyurethane foam doped with a polymeric gel without the drawbacks of the prior art.

A further objective of this invention is make flexible polyurethane foam doped with a polymeric gel that firmly maintains said polymeric gel anchored in a stable manner over time, and which does not change its characteristics in the long term.

A further objective of this invention is to make available a composite material for making items out of polyurethane doped with a polymeric gel that does not have any release or detachment of said polymeric gel.

A further objective of this invention is to make available a composite material for making items out of polyurethane doped with a polymeric gel that has a uniform distribution in the body of the polymeric gel.

A further objective of this invention is to make available a composite material for making items out of polyurethane doped with a polymeric gel that has improved thermal exchange properties.

A further objective of this invention is to make available a composite material for making items out of polyurethane doped with a polymeric gel that has appreciable characteristics of freshness that flexible polyurethane foam does not have because it is one of the best insulators.

A further objective of this invention is to make a polyurethane foam that has a high viscoelasticity value and therefore a higher energy absorption coefficient value compared to traditional polyurethane foams.

A further objective therefore of this invention is to provide a process for obtaining a polyurethane foam product that can provide the properties of the polymeric gel in an enduring and efficacious manner.

A further objective of this invention is to make available a procedure for making items out of polyurethane doped with a polymeric gel that is completely reliable.

A further objective of this invention is make a composite material for making items out of polyurethane doped with a polymeric gel, without using methods or additives that could harm people's health.

A further objective is to make available a procedure that ensures the secure holding of the polymeric gel also on the surface.

Another objective is to make available a procedure that allows you to prepare beforehand the components of the polyurethane mix.

These and other objectives are all attained with the composite material for making items out of polyurethane doped with polymeric gel, and with the procedure for making items out of polyurethane doped with polymeric gel according to the attached claims.

Other inventive aspects of the invention are described in the claims.

Additional characteristics and advantages of the process and the product will become clearer from the detailed description that follows of some preferred forms, provided by way of example.

### DESCRIPTION OF THE DRAWINGS

The technical characteristics of the invention, in line with the above-mentioned objectives, can clearly be found in the contents of the claims above and the benefits of it are even more evident in the detailed description that follows, made with reference to the attached diagrams, which depict a form that is provided purely by way of example and non-binding, where:

FIG. 1 shows a diagram of a ramp compression DMA analysis with a temperature between −60° to +100° C. at 5° C./min (frequency 1 Hz) referring to a non-doped

FIG. 2 shows a diagram of a ramp compression DMA analysis with a temperature between −60° to +100° C. at 5° C./min (frequency 1 Hz) referring to a sample doped with polymeric gel (with a percentage of about 10%);

FIG. 3 shows an enlarged photo of the cellular structure of a standard polyurethane with a graduated scale in mm.; and

FIG. 4 shows an enlarged photo of the cellular structure of the polyurethane foam that is the object of the invention, with the chips or granules of the polymeric gel highlighted with arrows.

### DETAILED DESCRIPTION OF THE PREFERRED EMBODIMENT

The composite material and the procedure set out in the invention are preferably to be used for making mattresses, pillows, and bedding articles in general. The product is made from two products of a different nature.

The flexible polyurethane foam is composed of two components A and B; component B is an isocyanate, component A is a mix of different polyoils doped with catalysts, water and various additives.

The second product is a polymeric gel.

Preferably, but not essentially, the polymeric gel is chosen from the family of thermoplastics, is a SEBS rubber (Styrene-Ethylene-Butylene-Styrene), and the plastic phase is generally of a polyolofinic nature.

The advantages of using the above-mentioned gel for making items to be used in bedding are that it is chemically very stable, releasing little plasticizer, it is sanitary, namely inert and nontoxic, and it is washable.

Preparation takes place in the following way: the polymeric gel is reduced to chips or granules with dimensions that can range from a fraction of a millimeter to 5 millimeters. The polyurethane can be of various types, flexible elastic foam, viscoelastic with high or low resilience, slow return or immediate return (when squashed the recovery time to the initial position depends on the type of polyurethane), this goes for all types of flexible polyurethane foam.

The chips of polymeric gel are immersed and mixed using an agitator that disperses them evenly in a mix of component A.

The percentages of gel of the total of the end product can go from a minimum of 2% to a maximum of 50%.

The best results were obtained with a gel percentage from 5% to 20% of the total of the end product.

Getting back to the preparation, once the gel is mixed with the mix of polyoils and various additives (this mix later in the description will be identified as mix with gel) you proceed to the making of the product that takes place by making the mix with gel component react with the isocyanate.

Very conveniently, the immersion of the polymeric gel into the polyoil is done in a time from the preparation of the isocyanate and polyoil mix of about half an hour to about 4 hours, and preferably 2 hours, and this allows the polyoil to penetrate inside the gel, something that is important for our purpose; in fact, because the polyoil is a macromolecule it remains partially outside the gel, allowing the gel itself to bind in the reaction phase with the isocyanate part to form the polyurethane; the end result is a gel, that although a solid inert substance, is retained, and when it is used the resultant polyurethane does not have gel granules that detach from it.

Another production method also beneficially provides for the combining of the polymeric gel with one of the components of the polyurethane mix a long time before the foaming, from a few hours up to 48 hours. This preparation provides for the immersion of the gel into the isocyanate: the gel is immersed into the isocyanate to avoid the problem of the gel being absorbed by the mix (which is a blend of polyoils, water, catalysts and various additives) that by penetrating over time inside the molecule of the polymeric gel would render the gel saturated with the polyoil after the reaction, making it unusable. The bottom of the storage tank because of the effects of gravity. The doping of the polymeric gel should take place gradually.

The result is a microcellular elastic foam compound with physical and mechanical characteristics that are comparable to those of the starting polyurethane, which in addition has a high increase in viscoelasticity.

This increase in viscoelasticity gives the product a higher energy absorption coefficient.

The product that is obtained acquires also the qualification as an anti-bedsore material since the polymeric gel parts, and especially those parts near the surface, incorporated and held by the polyurethane of the matrix, have a very modest hardness, squashed under the weight of the user to such a degree that they cannot be felt or noticed as bumps, have considerable resistance to abrasion, resistance to UV rays, and because they have a high thermal capacity also provide a feeling of freshness.

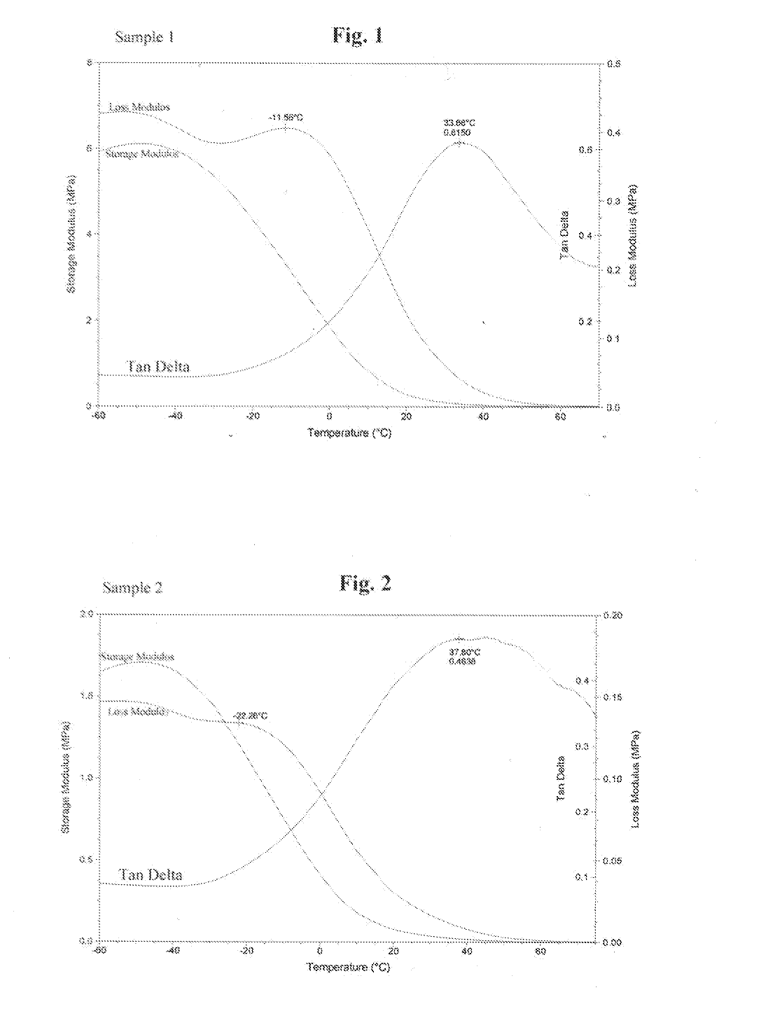

In order to more effectively highlight this characteristic, tests were carried out at specialized labs, and FIGS. 1 and 2 respectively refer to a sample of non-doped polyurethane and a sample of polyurethane doped with polymeric gel (with a percentage of about 10%).

From the diagrams we can appreciate in particular the increase in viscoelasticity that gives the product a higher energy absorption coefficient, almost 3 times that of traditional polyurethane foam.

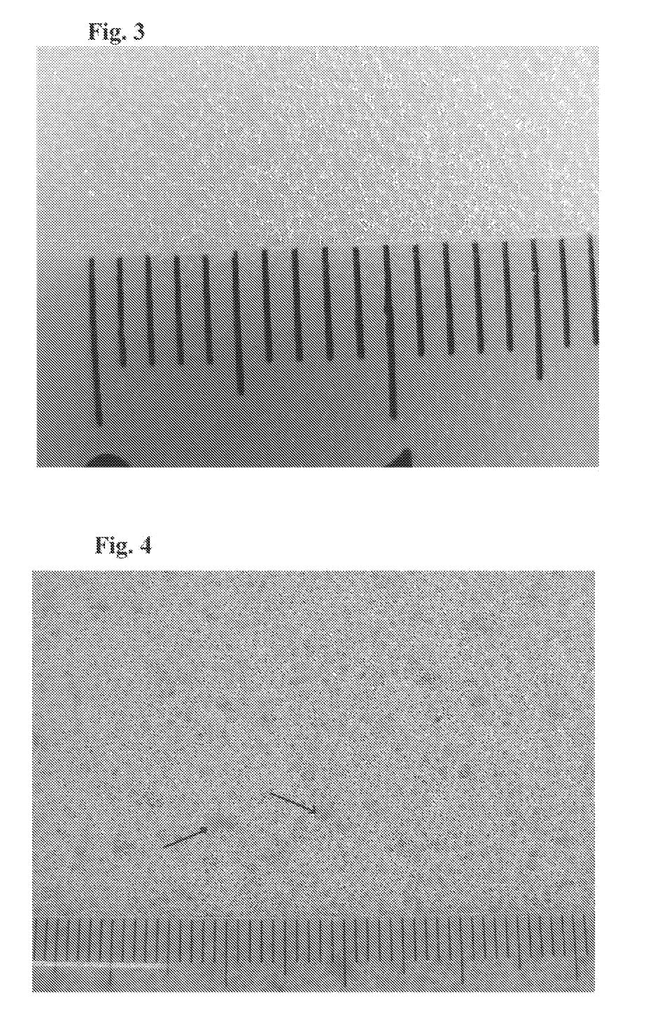

To assess how the chips or granules of the polymeric gel are arranged in the cellular body of the polyurethane, photos were made; the first in FIG. 3 shows the standard structure of the cellular mass of a generic polyurethane, while in FIG. 4 we can see the uniform distribution throughout the cellular mass of said polymeric gel chips and granules, pointed out by arrows.

The flexible polyurethane foam production process can be carried out using molding in specially made molds for single products that already have a form, or using continuous foaming, with the production of long blocks to be cut and shaped.

In this way you obtain a family of flexible polyurethane materials in a variety of hardness, but whose performance satisfies customers' tastes and requirements, who very often assess a product on the basis of first impressions, its touch and crush resistance. With the product made according to the procedure set out above, manufacturers are in a position to be able to guarantee durable properties without any undesirable detachment of the doped gel.

In fact, only with this method is there a guarantee in the long term that the performance of the doped end product will remain unchanged.

1. A composite material for making an article with polyurethane foam comprising a silicone gel evenly distributed throughout the material in a concentration of between 2% and 50% of the total mass of the article.

2. (canceled)

3. The composite material according to claim 1 wherein said silicone gel is in the form of scales or granules with dimensions ranging from less than a millimeter to 5 millimeters.

4. The composite material according to claim 1 wherein said silicone gel belongs to the family of thermoplastics.

5. The composite material according to claim 1 wherein said silicone gel is an SEBS rubber.

6. The composite material according to claim 1 wherein said silicone gel is an SEBS rubber wherein the plastic phase is of a polyolofinic nature.

7. The composite material according to claim 1 having an increased viscoelasticity equal to at least three times that of traditional polyurethane foam.

8. A procedure for making an article out of polyurethane foam comprising the steps:
preparing a polyoil-based component and a silicone gel;
reducing the silicone gel to granules with dimensions ranging from less than a millimeter to 5 millimeters;
mixing said silicone gel granules in said polyoil base to form a mixture;
combining said mixture with an isocyanate component in order to obtain a polyurethane foam mixture.
delivering the polyurethane foam mixture on a foaming line;
polymerizing said polyurethane foam mixture until a product obtained from the polymerization of said polyurethane foam mixture can no longer become deformed under its own weight; and
cutting the blocks obtained from the foaming line.

9. The procedure of claim 8 wherein the step of mixing said silicone gel granules in said polyoil base to form a mixture takes place between three and four hours before combining said mixture with an isocyanate component in order to obtain a polyurethane foam mixture.

10. The procedure of claim 8 wherein the step of mixing said silicone gel granules in said polyoil base to form a mixture takes place about two hours before combining said mixture with an isocyanate component in order to obtain a polyurethane foam mixture.

11. The procedure of claim 8 wherein the polymeric gel granules are combined with the isocyanate component between three hours and forty-eight hours before the preparation of the mix to be combined with the polyoil component.

12. A procedure for making an article out of polyurethane foam comprising the steps:
preparing a polyoil-based component and a silicone gel;
reducing the silicone gel to granules with dimensions ranging from less than a millimeter to 5 millimeters;
mixing said silicone gel granules in said polyoil base to form a mixture;
combining said mixture with an isocyanate component in order to obtain a polyurethane foam mixture.
delivering the polyurethane foam mixture inside a mold;
polymerizing said polyurethane foam mixture until a product obtained from the polymerization of said polyurethane foam mixture can no longer become deformed under its own weight; and
extracting said product from said mold.

13. The procedure of claim 12 wherein the step of mixing said silicone gel granules in said polyoil base to form a mixture takes place between three and four hours before combining said mixture with an isocyanate component in order to obtain a polyurethane foam mixture.

14. The procedure of claim 12 wherein the step of mixing said silicone gel granules in said polyoil base to form a mixture takes place about two hours before combining said mixture with an isocyanate component in order to obtain a polyurethane foam mixture.

15. The procedure of claim 12 wherein the polymeric gel granules are combined with the isocyanate component between three hours and forty-eight hours before the preparation of the mix to be combined with the polyoil component.
